(19) United States
(12) Patent Application Publication
(10) Pub. No.: US 2012/0330705 A1
(43) Pub. Date: Dec. 27, 2012

(54) SYSTEM AND METHOD TO PROVIDE AUTOMATIC GEOGRAPHIC ALLOTMENT RELEASE IN A LOGISTICS MANAGEMENT SYSTEM

(76) Inventor: Karen Berg, Eajan, MN (US)

(21) Appl. No.: 13/169,098

(22) Filed: Jun. 27, 2011

(51) Int. Cl. G06Q 10/08

(52) U.S. Cl. 705/7.12

(57) ABSTRACT

Disclosed is a logistics management system (LMS). The LMS has a host computer system for executing the LMS. A user interface module is used in conjunction with the system module of the host computer. The user interface module may have information fields, where at least one of the information fields is a lead time that is used along with a departure time associated with a transportation event to determine a release time. The release time indicates when to adjust an allotment associated with the transportation segment.

Disclosed is a method for use in a LMS. A field stored on a database of the LMS is retrieved. The field may be a lead time. The lead time of the field may be used along with a departure time associated with a transportation event to determine the release time.

Disclosed is a method for generating a report from a LMS. A lookup capability of a lead time value that corresponds with a lookup geographic attribute is provided. The lead time value is used to measure when a space allotment is released relative to a transportation event to occur at a location represented by the geographic attribute. Input is received from a user to establish a release control profile. The input may be an input geographic attribute. The input geographic attribute is matched with the lookup geographic attribute to define when the space allotment is to be released relative to the transportation event.

### BACKGROUND

In transportation, businesses sometimes guarantee space (allotments) for customers to use to make reservations up until a time period near a transportation event, when customers utilize their guaranteed space or lose their reservation. Manually releasing unused space that has been reserved is time-consuming and mistake-prone.

Therefore, there is a need in the art for a solution that maintains releasing allotments in a manner that is less time-consuming, mistake-prone, and problematic for transportation business.

### SUMMARY

Disclosed is a logistics management system (LMS). In one embodiment, the LMS has a host computer system for executing the LMS. A user interface module is used in conjunction with the system module of the host computer. The user interface module may have information fields, where at least one of the information fields is a lead time that is used along with a departure time associated with a transportation event to determine a release time. The release time indicates when to adjust an allotment associated with the transportation segment.

Disclosed is a method for use in a logistics management system (LMS). In one embodiment, a field stored on a database of the LMS is retrieved. The field may be a lead time. The lead time of the field may be used along with a departure time associated with a transportation event to determine a release time. The release time indicates when to adjust an allotment associated with the transportation event.

Disclosed is a method for generating a report from a LMS. In one embodiment, a lookup capability of a lead time value that corresponds with a lookup geographic attribute is provided. The lead time value is used to measure when a space allotment is released relative to a transportation event to occur at a location represented by the geographic attribute. Input is received from a user to establish a release control profile. The input may be an input geographic attribute. The input geographic attribute is matched with the lookup geographic attribute to define when the space allotment is to be released relative to the transportation event.

### BRIEF DESCRIPTION OF THE DRAWINGS

So that the manner in which the above recited features of the present disclosure are attained and can be understood in detail, a more particular description of the disclosure, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 is a block diagram illustrating an exemplary network-based environment 100 in which logistics management system 110 provides network-based management of freight transportation;

FIG. 2 is a block diagram illustrating an exemplary embodiment of logistics management system 110 in further detail;

FIG. 3 illustrates a flowchart of a method 300 in accordance with one embodiment;

FIG. 4 illustrates a flowchart of a method 400 in accordance with one embodiment;

FIG. 5 illustrates an example depiction of a screen capture of an Allotment Information page layout 400;

FIG. 6 illustrates an example depiction of a screen capture of an Allotment Administration page layout 600;

FIG. 7 illustrates an example depiction of a screen capture of an Allotment Administration page layout 700;

FIG. 8 illustrates an example depiction of a screen capture of an Allotment Administration page layout 800;

FIG. 9 illustrates an example depiction of an output 900;

FIG. 10 illustrates a method 1000 for use in a logistics management system (LMS); and

FIG. 11 illustrates a method 1100 for generating a report.

### DETAILED DESCRIPTION

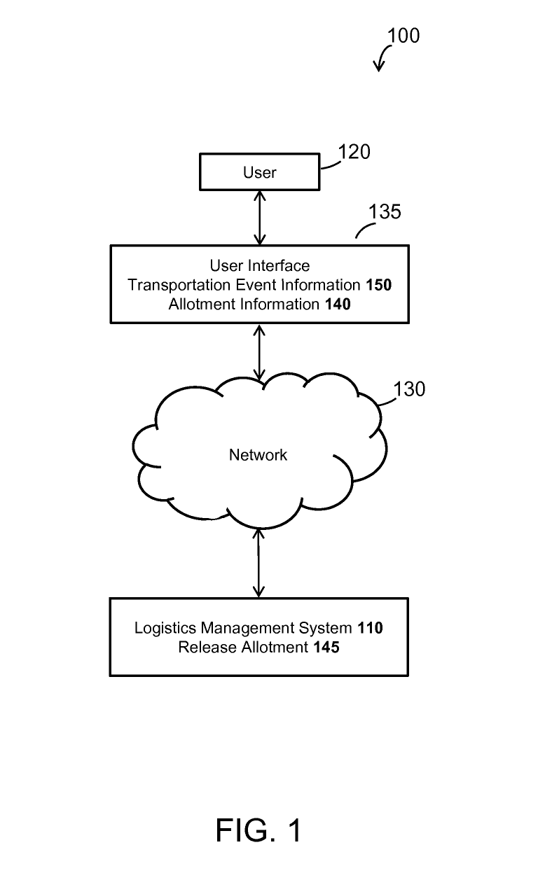

FIG. 1 is a block diagram illustrating an exemplary network-based environment 100 in which logistics management system 110 provides network-based management of freight transportation. As described in detail herein, logistics management system 110 provides a task-oriented user interface 135 with which an authorized user 120 or users of a transportation system interact with the logistics management system 110 to perform a wide range of tasks associated with transportation management. Transportation involved may be an airline, truck, bus, ship, train, and the like. A user 120 may be, for example, a station manager, office personnel, warehouse staff, space control staff and the like. Exemplary tasks comprise a capture of transportation data, a track or trace of transportation events, capacity control, container control, terminal management, financial management, consolidation and other common freight tasks.

With relation to the task of keeping track of reserving space for freight, the logistics management system 110 holds space under reservations up until an amount of time before the transportation event is planned to depart. To be more efficient and assist in business organization, one embodiment of this disclosure releases the reserved allotment of unused space for a transportation event automatically. Without specifying a closing time, the user 120 may simply indicate how long before the transportation to release the allotment 145 via some allotment information 140. In another embodiment, the user 120 may even rely on details of the transportation event and enter as little information as the transportation event information 150, for example, geographic information about the departure. In response, the logistics management information system 110 is able to release the allotment 145 automatically in system-generated amount of time that is appropriate to the distance involved in that instance. Within the allotment release 145, the logistic management system 110 may handle the automatic release via a batch process running periodically, a stand-alone module, or the like.

In this way, freight space is made available to other customers who may be more likely to use the allotted space, and thus, freight space would likely be used more efficiently and fully per transportation event.

In one embodiment, the user 120 typically accesses logistics management system 110 via a user interface 135 communicating over network 120 using a remote computing device, terminal box, workstation, personal computer, laptop computer, personal digital assistant, mobile phone, tablet computer, having suitable communication software, e.g., a web browser, or other network-enabled device. The network-enabled device would not be limited by its operating system, given that the device has an ability to display information to the user 120 and input information from the user 120 via a mouse, keyboard, voice recognition, and the like.

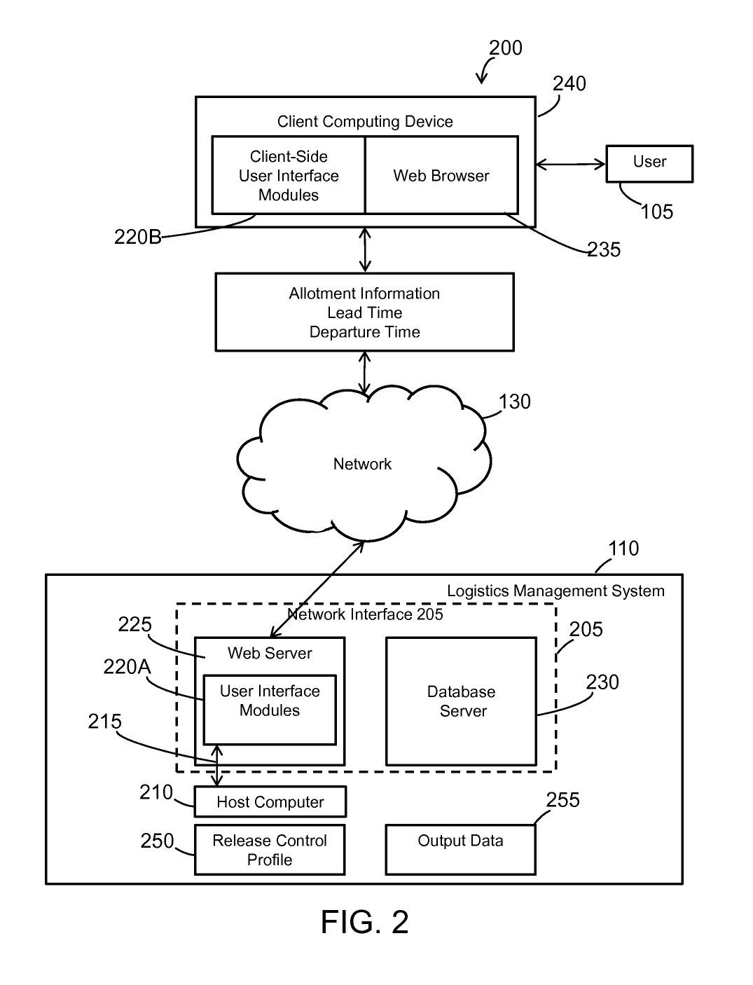

FIG. 2 is a block diagram illustrating an exemplary embodiment of logistics management system 110 in further detail. In the exemplary embodiment, logistics management system 110 comprises a host computer 210 coupled to network 120 via network interface 205. In general host computer 210 provides a computing platform for hosting shipment management services for logistics service providers. Host computer system 210 may comprise, for example, a mainframe executing logistics management software.

Network interface 205 comprises one or more computing devices, e.g., web server 225 and database server 230, that cooperate to provide a seamless network-based interface by which remote user 120, e.g., at least one of users 120, access host computer 210. Although host computer 210, web server 225, and database server 230 are illustrated separately in FIG. 2 for exemplary purposes, logistics management system 110 may be realized by a single computing device or a plurality of cooperating computer devices.

Web server 225 provides a web-based interface by which an authorized user 120 communicates with logistics management system 110 via network 120. In one configuration, web server 225 executes web server software. As such, web server 225 provides an environment for interacting with remote user 120 via user interface modules 220A, 220B (collectively “user interface modules 220”). As described in detail below, user interface modules 220 provide a task-oriented interface with which user 120 interacts to perform a wide-range of tasks associated with shipment management. User interface modules 220 may comprise Active Server Pages, web pages written in hypertext markup language (HTML) or dynamic HTML, Active X modules, Java scripts, Java Applets, Distributed Component Object Modules (DCOM), and the like.

Moreover, user interface modules xxx may comprise “server side” user interface modules 220A that execute within an operating environment provided by web server 225, “client-side” user interface modules 220B that are downloaded to and executed on a client computing device 240 of remote user 120, or combinations thereof. Client-side user interface modules 220B could, for example, comprise Active X components, Java scripts executed by web browser 225 executing on client computing device 240.

In one embodiment of the disclosure, the user interface 120 appears to the user as a graphical set of interrelated screens. Logistics management system 110 may present the screens of the user interface 120 in a consistent manner that allows the user to perform tasks by interacting with as few as a single input screen.

Using the input from the user 120, user interface modules 220 interface with data base server 230 to store and retrieve one or more items, such as data related to transportation information 150, allotment information 140, release control profile 250, output data 255 and the like. For example, user 120 may interact with logistics management system 110 to indicate an amount of lead time before the departure time of a transportation event occurs that space allotted may be released to be booked. The user 120 may even indicate an amount of lead-time before a segment of a transportation event reaches a departure time to release an allotment of its space for transport. Database server 230 may provide an operating environment for a database management system for storing the allotment values, lead time, event departure time, segment departure times of the event, and the like. The database management system may be a relational, hierarchical, multidimensional, object-oriented, or object relational database management system. In another embodiment, an array, direct entry, or other method of storage may be used. In one embodiment, a file that is manually created by a user may contain a list of allotments that may be automatically released.

Specifically, logistics management system 110 receives input from the user 120, via for example, an input screen with informational fields to enter data for the logistics management system. Input screens may even be organized into regions. Given the organization, the user 120 is at an advantage to use this system because the input screens' layouts may be more intuitive and require less training. In general, the item selection region allows the user to identify one or more items, e.g., a cargo item, person, event, flight, or the like. The activity region of the screen allows the user 120 to provide input data for a defined set of activities or steps associated with the task, i.e., activities for completion of the overall task. The action region allows the user 120 to perform one or more actions on the item specified with item selection region based on the data specified within activity regions, thereby completing an overall shipment management task with a single action. In this manner, the user 120 need not interact with multiple screens to complete the various activities associated with an overall task.

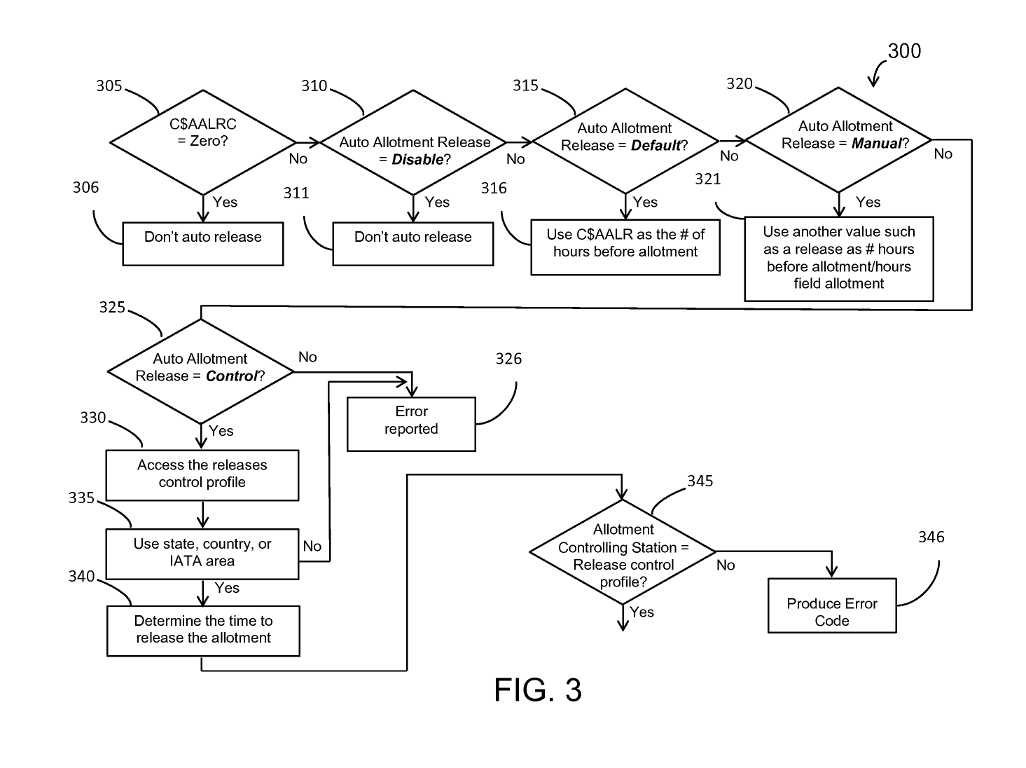

The task-oriented nature of the interface provided by logistics management system 110 facilitates ease of use by the users, even by relatively untrained individuals. As a result, logistics management system 110 may achieve a reduction in human-related errors, as well as reduced training costs. Moreover, by allowing the user to initiate multiple cargo management activities with a single entry, the system may achieve increased employee productivity. Input screens will be discussed further in conjunction with FIGS. 3-7.

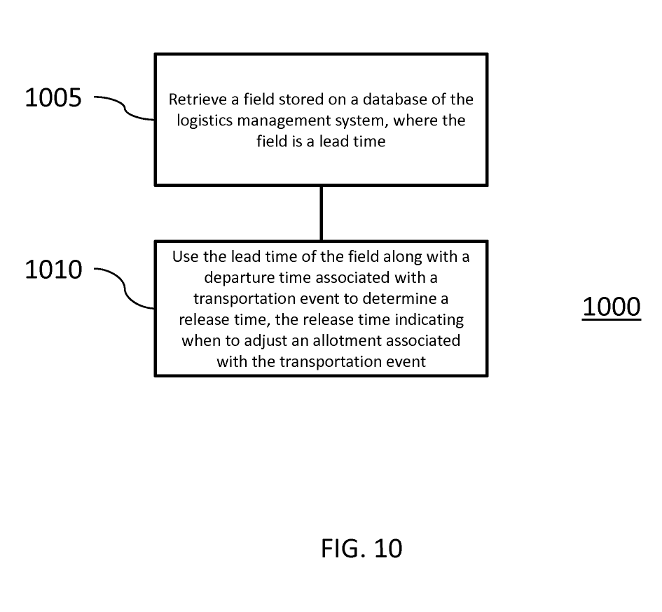

After logistics management system 110 runs its method of processing allotment releases like a maintenance batch process, the system 110 may report an optional output file to record information concerning an allotment release, debugging information, or the like. Later in this specification, FIG. 10 will detail an exemplary output file.

FIG. 3 illustrates a flowchart 300 of a method for the logistics management system 110 to process allotment releases in accordance with one embodiment of the present disclosure. This method 300 by the logistics management system gives users more control over whether to automatically release space allotments, how much lead time to give before releasing an allotment, overriding with another value of lead time, opting to simply enter the geographic information about the transportation event for the lead time to be determined by the system.

At step 305, logistics management system first checks if the user has set a clue for the system to opt out of using an automatic allotment release. In this embodiment, if the user has set a value to zero, the user indicates to not use an automatic release at step 306, and the system stops the automatic release process for that transportation event.

If the user has indicated to use automatic allotment release, then in step 310, the logistics management system 110 may also offer an explicit factor for a user to set to disable for a specific allotment when the user prefers the system to not release space automatically. In this example, the system has a factor, e.g., indicator, called Auto Allotment Release and verifies in step 310 whether a user set it to disable. If so, the process terminates and does not automatically release an allotment for that transportation event (step 311). The factor Auto Allotment Release may be a variable, setting, array, switch or other communication of a user's preference.

If the Auto Allotment Release factor is not set to disable, then the system continues to step 315. In step 315, the system evaluates whether the factor, for example, Auto Allotment Release is set to default. If Auto Allotment Release is set to default, in one embodiment, a parameter C$AALR may be used as the number of hours before an allotment is released in step 316. In one embodiment, a user may use the same option used to set to zero to indicate to not auto release, as a value to not only auto release but also the value of the option indicates the amount of lead time to use of when to release the allotment reserved on the relevant transportation event.

If the user would like to use another value for lead time of allotment release, the user may set the Auto Allotment Release factor to Manual at step 320 and use another value instead in step 321.

If the user would rather submit geographic information for the system to determine the lead time for allotment release, the user may indicate so by choosing a value for the option, for example, Control in step 325. If not, then the option may equal any number of other values defined in an embodiment. After all the options are exhausted, then if the option has not equaled any possible values defined, then the system may produce an error report at step 326.

If the option equals Control, then in step 330, the system accesses information to compare to the transportation event. The comparison information may be called a release control profile in some embodiments.

The user may enter such geographic information as a transportation event's state, country, IATA area, or the like, of a departure or arrival destination. In step 335, the system uses the geographic information to compare to the release control profiles. If the geographic information does not equal any possible values defined, then the system may produce an error report at step 326. Based on the comparison, the system is able to determine an appropriate lead time for releasing allotment of the transportation event in step 340. In step 345, if the geographic information or other information to control an allotment station is not able to find a comparable release control profile, then the system produces an error code or records the events into a debug file at step 346.

To further explain step 325, which concerns a user furnishing geographic information for the system to determine the allotment release time, one may use method 400 as an alternative or in conjunction with step 325.

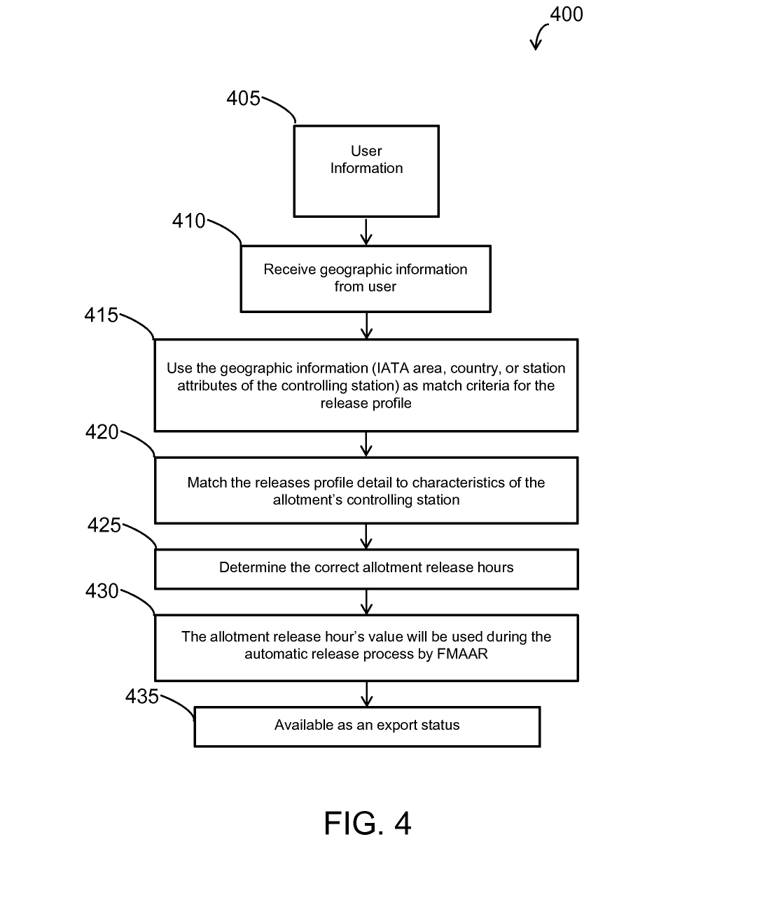

FIG. 4 illustrates a flowchart of a method 400 in accordance with one embodiment. At step 405, a user provides information to the logistics management system. This information may be entered directly to the system, entered into storage to be delivered to the system, chosen from options presented by the system, transmitted to the system remotely, or the like. A portion of this information comprises information entered into screens presented by the user interface.

At step 410, the logistics management system receives the information from the user. One type of information useful to the logistics management system would be geographic information, for instance, a country from which an airplane may take off, a city where a bus will arrive, a coast where a ship will load up cargo, and the like. Other geographic information comprises an International Air Transport Association area, transportation station, global positioning system point, or the like.

At step 415, the logistics management system may use the geographic information as match criteria. One resource to compare for matches is release profiles, which indicate what lead time is chosen for releasing allotments for certain transportation events. Release profiles may be pre-created by the user, already be an established part of a logistics management system's database, loaded into the system by a third party or the like.

At step 420, the logistics management system matches the geographic information from the user in the form of an allotment's controlling system with release profile details. After a match is found, at step 425, the system determines the correct allotment release. The allotment release might be in the form of a lead-time of hours before a transportation event, a clock time, or the like.

At step 430, the system uses the allotment release data to release unused space on a transportation event at a designated time automatically without any further input or action from the user. As a follow up to the automatic release in step 435, the system may create a status to export, for example, an output file of debugging information or a record of the events.

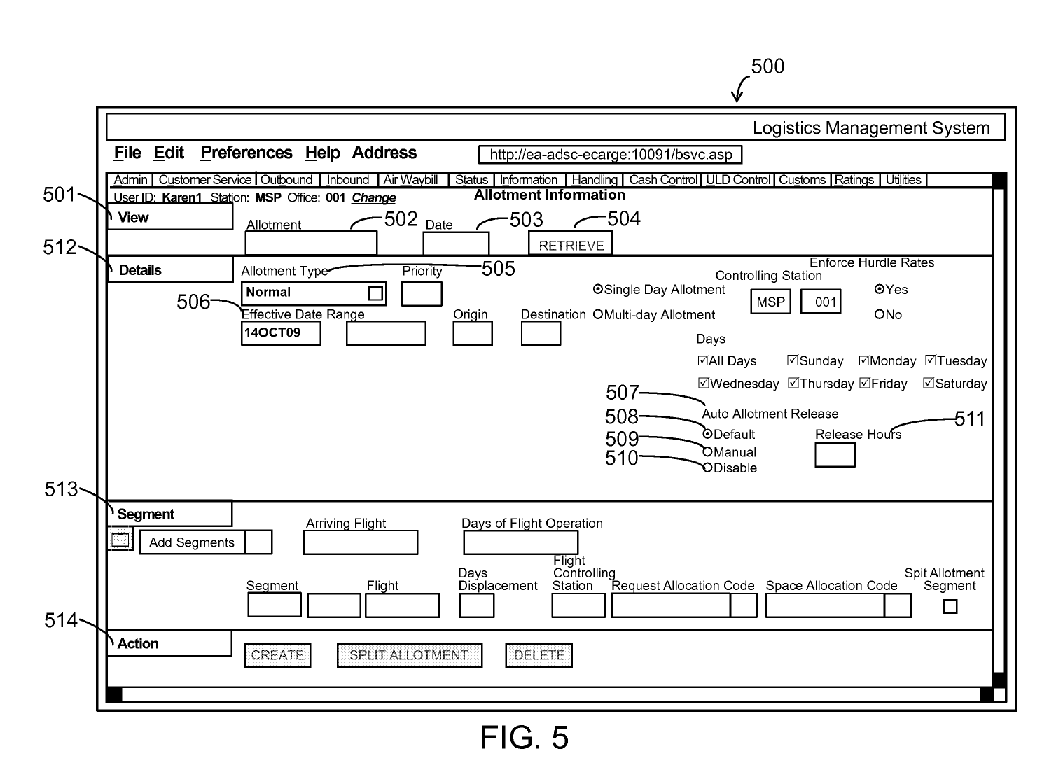

FIG. 5 illustrates an example depiction of a screen capture of an Allotment Information page layout 500. This example shows an embodiment that uses organizational regions for the screen, e.g., regions named View 501, Details 512, Segment 513, and Action 514. Within the View 501 region of the screen 500, a user may use a retrieve 504 function, for example, a button, to look up allotments 502 by lead time or date 503.

In the Details 512 region, a user may observe more particulars about one or more allotment releases. Screen 500 defines data for a single/specific Allotment. Details region 512 contains other data besides the release data. In the displayed embodiment, a user may verify information that is available for an allotment. Information that might display comprises an allotment's type 505, priority, effective date range 506, and an origin and destination of the transportation event. The details region might also show whether the allotment concerns a single day or multiple days, which controlling station is associated with the transportation event, and what days apply for the allotment release. In this embodiment, radio buttons show the style of automatic allotment release 507, which comprises possibilities of default 508, manual 509, and disable 510 in this embodiment. The release hours may also be displayed in the Display region, if that information is available.

In the segment region of the input screen, a user may manage segment details of a transportation event. A user instructs actions to be taken such as deleting or adding segments to a transportation event. In some embodiments that comprise an allotment release for a transportation event that comprises multiple transportation segments, the logistics management system releases the allotment for the multiple segments at the appropriate time for the first segment of event.

In the action region at the bottom of the screen, a user indicates whether the user would like to create or update an allotment, split an allotment, or delete an allotment, which in some embodiments, lead to other interactive screens.

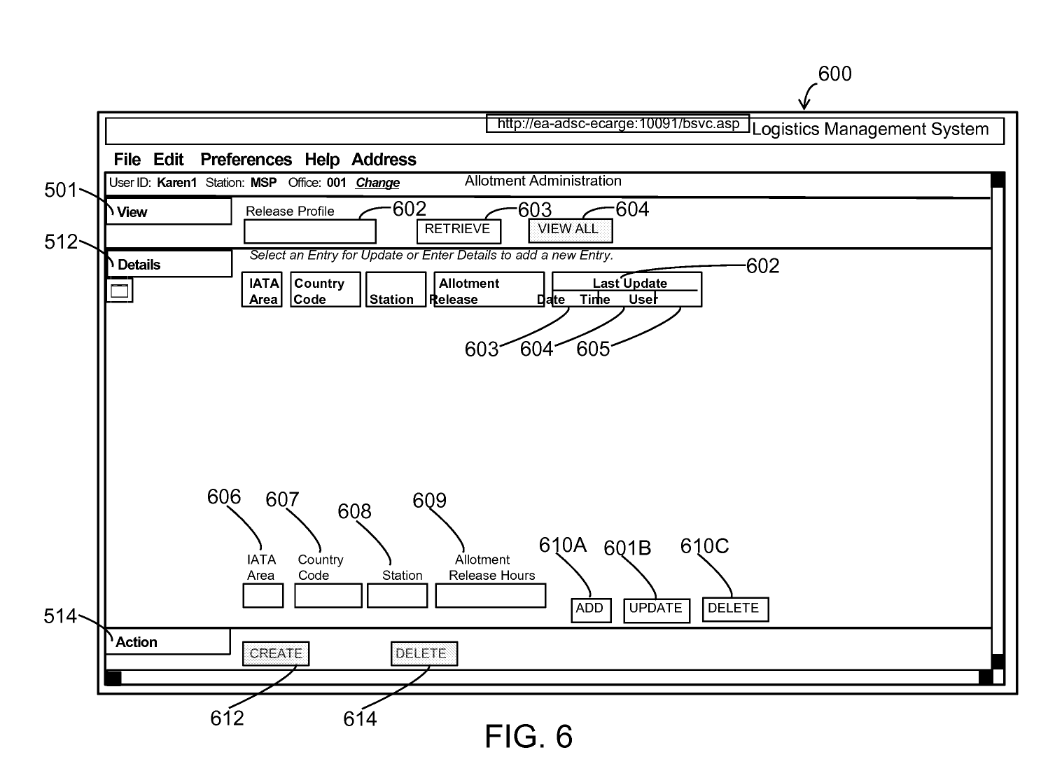

FIG. 6 illustrates an example depiction of a screen capture of an Allotment Administration page layout 600. FIG. 6 may be accessed from a menu. A user may create, update, or delete profiles; profiles indicate when a user would choose for an allotment space to be automatically released prior to a transportation event, sometimes based on geographic areas. Because the system offers an updating option to the profiles, they are flexible in this way to changes in industry abilities like fuel economy or more powerful engines. A user has more control over when the allotments are released and what times become more appropriate as technology changes.

In a Details region 512, a user may update an existing allotment release entry or add a new entry. By simply entering geographic details, such as an IATA 606, country code 607, station 608, the user must enter a lead-time for allotment release. 609. After choosing what to enter into which textbox, the user may press Add 610A, Update 610B, or Delete 610C to respectively add, update, or delete a lead time of an allotment release.

This example shows an embodiment, which offers a user some choices that may be duplicates from the FIG. 5 previous screen layout, e.g., the View 501 and Action 514 regions. By duplicating some regions from the previous screen, this embodiment continues to be user-friendly and efficient for training.

This screen capture shows an Action region of the screen that comprises a Create 612, and Delete 614 boxes, which could be used as interactive buttons to initiate the respectful action. Inside the Details region of the screen capture, a user may enter information about the transportation event, for example in this embodiment, geographic information of IATA area 606, country code 607, and/or station 608. If the user would like to enter an amount of hours before the transportation event that the allotment release should happen, the user can enter the hours into allotment Release Hours 609. Stored profiles would display inside the Details 512 region, along with details of their last update.

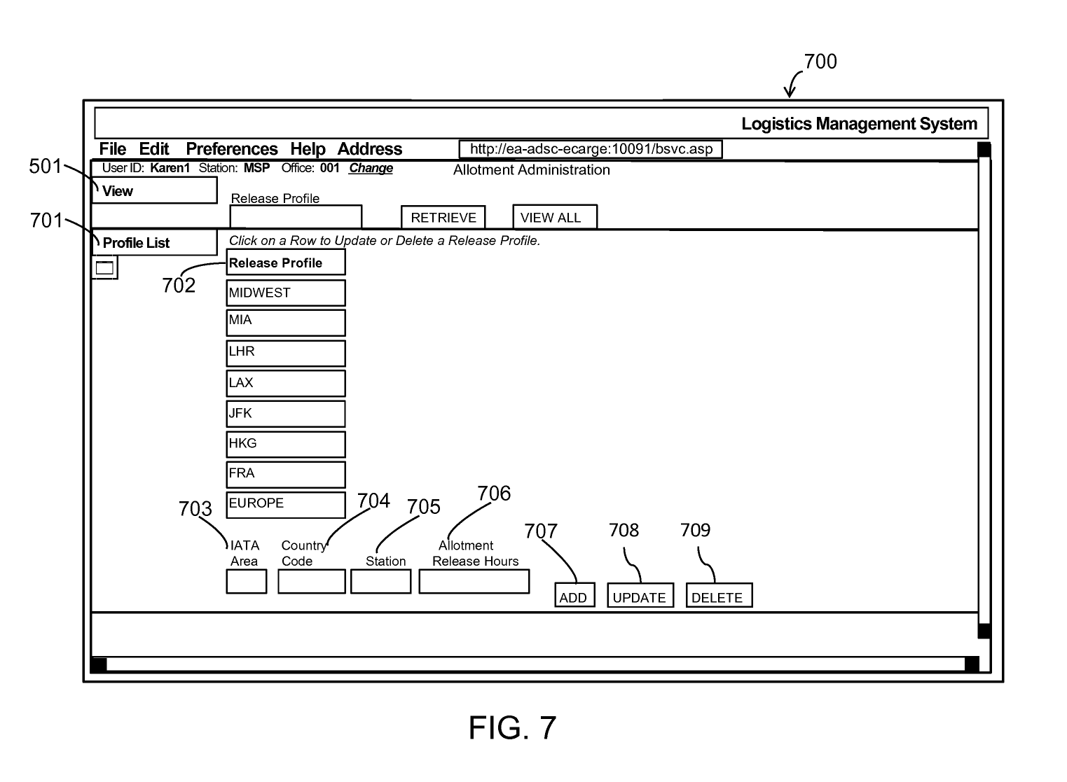

FIG. 7 illustrates an example depiction of a screen capture of an Allotment Administration page layout 700. In the Profile List 701 region of the screen, this embodiment displays some stored release profiles for a user to delete, update, or provide another profile. The user continues to have access to a View region 501 to pull up alternate profiles to view. This screen capture shows Profile List region of the screen that comprises an Add 707, Update 708, and Delete 709 boxes, which could be used as interactive buttons to initiate the respectful action. Inside the Profile List region of the screen capture, a user may enter information about the transportation event, for example in this embodiment, geographic information of IATA area 703, country code 704, and/or station 705. If the user would like to enter an amount of hours before the transportation event that the allotment release should happen, the user can enter the hours into allotment Release Hours 706.

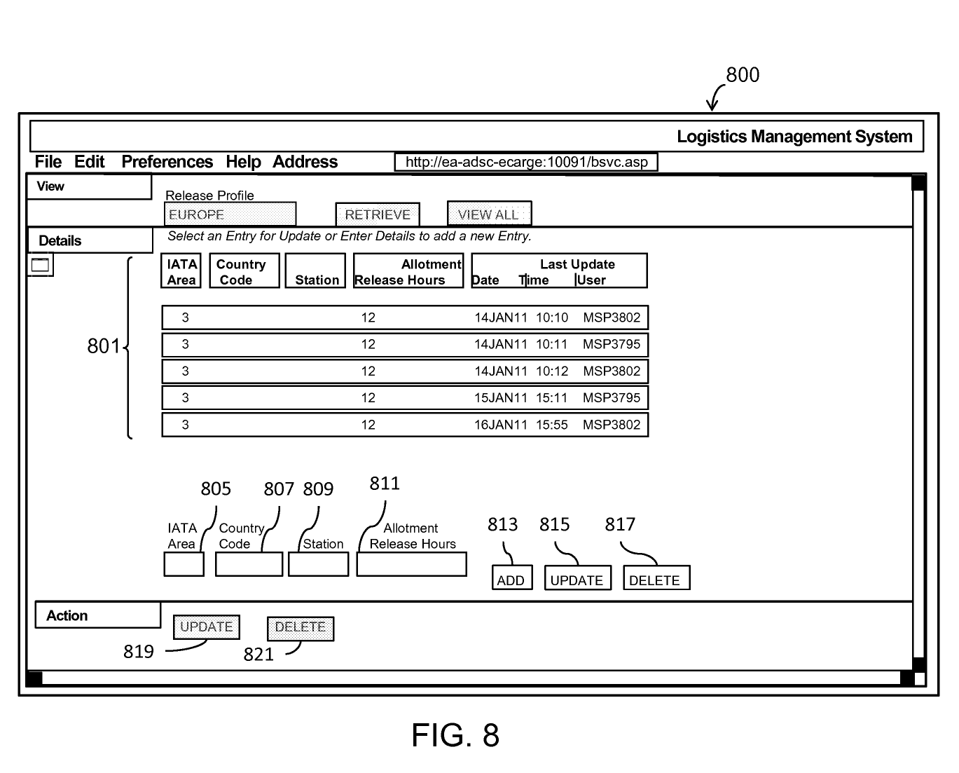

FIG. 8 illustrates an example depiction of a screen capture of an Allotment Administration page layout 800. In this embodiment, a user has input Europe into the release profile textbox within the View region. In the region of the screen 801, the screen displays profiles related to the search term, Europe, that are stored in this system.

This screen capture shows an Action region of the screen that comprises Update 819 and Delete 821 boxes, which could be used as interactive buttons to initiate the respectful action. This screen capture also shows a Details region of the screen that comprises Add 813, Update 815, and Delete 817 boxes, which could be used as interactive buttons to initiate the respectful action. Inside the Details region of the screen capture, a user may enter information about the transportation event, for example in this embodiment, geographic information of IATA area 805, country code 807, and/or station 809. If the user would like to enter an amount of hours before the transportation event that the allotment release should happen, the user can enter the hours into allotment Release Hours 811.

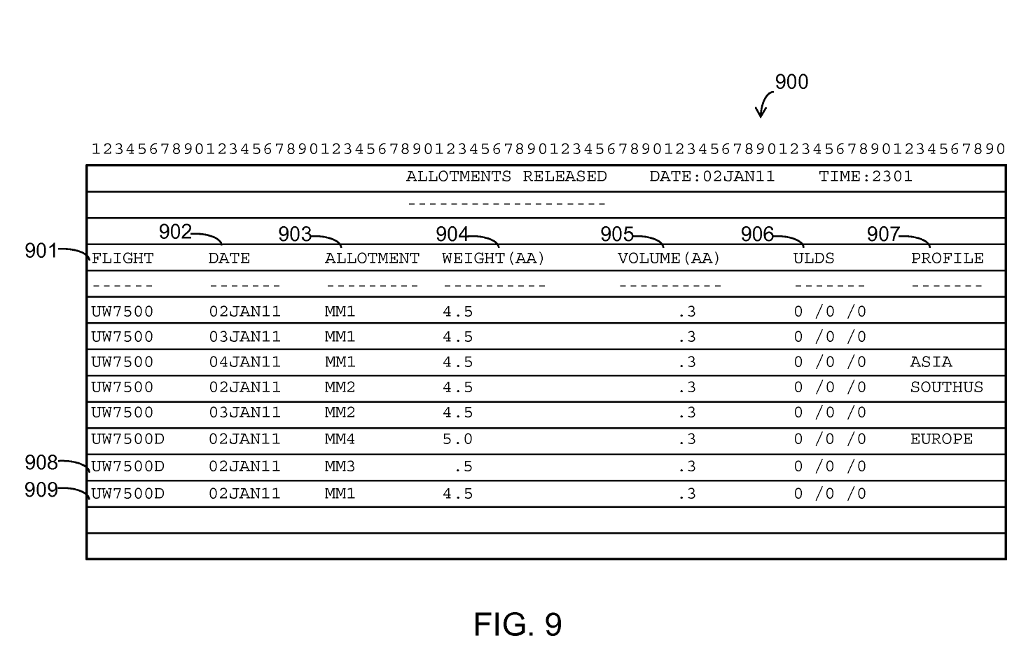

FIG. 9 illustrates an example depiction of an output 900. After a user enters allotment profiles or when allotments would be released, the user may be interested in what occurred during the process. A developer may also wish to know the results in order to debug more effectively. Logistics Management System 110 may generate output 900, which may be an output file, debugging file, tweet, or the like. In this embodiment, the logistics management system records what allotments have been released. Particularly, it keeps note of the flight 901, date 902, allotment 903, weight 904, volume 905, ULDS (Unit Load Devices) 906, and profile name 907, if any.

FIG. 10 illustrates a method 1000 for use in a logistics management system (LMS). A field that is stored on a database of the LMS is retrieved from the database. The field may be a lead time. The lead time of the field is used along with a departure time associated with a transportation event to determine a release time. The release time indicates when to adjust an allotment associated with the transportation event.

The allotment may be adjusted automatically. The allotment may be disabled from auto release. The lead time is input from a user interface.

In one embodiment, a determination is made as to whether there is an automatic allotment release indicator. In this embodiment release of the space availability on the transportation may be blocked when the automatic allotment release indicator is set to disable.

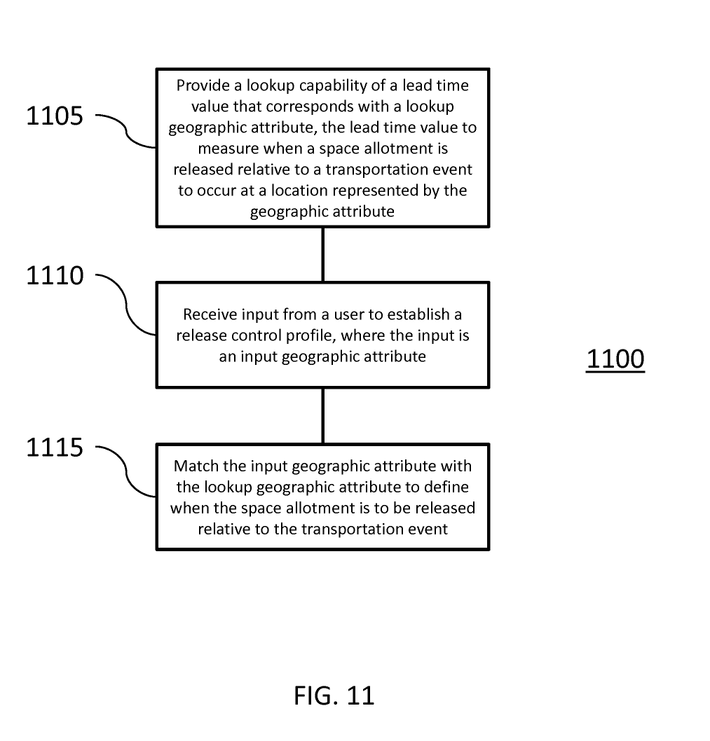

FIG. 11 illustrates a method 1100 for generating a report. A lookup capability of a lead time value that corresponds with a lookup geographic attribute is provided. The lead time value measures when a space allotment is released relative to a transportation event. The transportation event may occur at a location represented by the geographic attribute. Input is received from a user to establish a release control profile. The input may be an input geographic attribute. The input geographic attribute is matched with the lookup geographic attribute to define when the space allotment is to be released relative to the transportation event.

The input from the user may be used to generate other corresponding geographic data and other time values. The space allotment may be released when the space allotment is defined relative to the transportation event. A second space allotment may be released for a second leg of a multi-stop transportation event concurrently with a first space allotment of a first leg of the multi-stop transportation event.

The release control profile may be deleted if the user has deleted all geographic attributes within a release control profile. The report may be generated at a pre-defined interval via a batch process.

In one embodiment, the input geographic attribute is a transportation station. In one embodiment, the input geographic attribute is an IATA area. In one embodiment, the input geographic attribute is a country.

The processes described above, including but not limited to those presented in connection with FIGS. 3, 4, 10 and 11, may be implemented in general, multi-purpose or single-purpose processors. Such a processor will execute instructions, either at the assembly, compiled or machine-level, to perform that process. Those instructions can be written by one of ordinary skill in the art following the description of presented above and stored or transmitted on a computer-readable medium, e.g., a non-transitory computer-readable medium. The instructions may also be created using source code or any other known computer-aided design tool. A computer-readable medium may be any medium capable of carrying those instructions and include a CD-ROM, DVD, magnetic or other optical disc, tape, silicon memory (e.g., removable, non-removable, volatile or non-volatile), packetized or non-packetized wire line or wireless transmission signals.

While the foregoing is directed to embodiments of the present disclosure, other and further embodiments of the disclosure may be devised without departing from the basic scope thereof, and the scope thereof is determined by the claims that follow.

What is claimed is:

1. A logistics management system (LMS), comprising:
a host computer system for executing the LMS;
a user interface module for use in conjunction with the system module of the host computer, the user interface module comprising information fields, at least one of the information fields comprising a lead time that is used along with a departure time associated with a transportation event to determine a release time, the release time indicating when to adjust an allotment associated with the transportation segment.

2. The logistics management system of claim 1, wherein the release time may equal a number of hours when the allotment is enabled for auto release.

3. The logistics management system of claim 1, wherein the transportation event is an airline flight.

4. A method for use in a logistics management system (LMS), comprising:
retrieving a field stored on a database of the LMS, the field comprising a lead time;
using the lead time of the field along with a departure time associated with a transportation event to determine a release time, the release time indicating when to adjust an allotment associated with the transportation event.

5. The method of claim 4, wherein the allotment is adjusted automatically.

6. The method of claim 4, wherein the allotment is disabled from auto release.

7. The method of claim 4, the lead time is input from a user interface.

8. The method of claim 4, further comprising determining whether there is an automatic allotment release indicator.

9. The method of claim 8, further comprising blocking release of the space availability on the transportation when the automatic allotment release indicator is set to disable.

10. A method for generating a report, the method comprising:
providing a lookup capability of a lead time value that corresponds with a lookup geographic attribute, the lead time value to measure when a space allotment is released relative to a transportation event to occur at a location represented by the geographic attribute;
receiving input from a user to establish a release control profile, the input comprising an input geographic attribute;
matching the input geographic attribute with the lookup geographic attribute to define when the space allotment is to be released relative to the transportation event.

11. The method of claim 10, further comprising using the input from the user to generate other corresponding geographic data and other time values.

12. The method of claim 10, wherein, the method further comprises releasing the space allotment when the space allotment is defined relative to the transportation event.

13. The method of claim 10, wherein, the method further comprises releasing a second space allotment for a second leg of a multi-stop transportation event concurrently with a first space allotment of a first leg of the multi-stop transportation event.

14. The method of claim 10, wherein, the method further comprises deleting the release control profile if the user has deleted all geographic attributes within a release control profile.

15. The method of claim 10, wherein, the report is generated at a pre-defined interval via a batch process.

16. The method of claim 10, wherein, the input geographic attribute is a transportation station.

17. The method of claim 10, wherein the input geographic attribute is an IATA area.

18. The method of claim 10, wherein the input geographic attribute is a country.
